(19) United States
(12) Patent Application Publication
(10) Pub. No.: US 2012/0158791 A1
(43) Pub. Date: Jun. 21, 2012

(54) FEATURE VECTOR CONSTRUCTION

(75) Inventors: Gjergji Kasneci, Cambridge (GB); David Hector Stern, Cambridge (GB); Thore Kurt Hartwig Graepel, Cambridge (GB); Ralf Herbrich, Cambridge (GB)

(73) Assignee: MICROSOFT CORPORATION, Redmond, WA (US)

(21) Appl. No.: 12/975,177

(22) Filed: Dec. 21, 2010

(51) Int. Cl. G06F 17/30

(52) U.S. Cl. 707/798; 707/E17.03

(57) ABSTRACT

Feature vector construction techniques are described. In one or more implementations, an input is received at a computing device that describes a graph query that specifies one of a plurality of entities to be used to query a knowledge base graph that represents the plurality of entities. A feature vector is constructed, by the computing device, having a number of indicator variables, each of which indicates observance of a sub-graph feature represented by a respective indicator variable in the knowledge base graph.

### BACKGROUND

Machine learning algorithms may be employed for a variety of purposes. For example, a machine learning algorithm may be used to categorize data, form clusters of entities having similar characteristics, make recommendations relating to content, rank results in an Internet search, analyze data in an enterprise, and so on.

Machine learning algorithms typically employ vectors to represent entities that are the subject of the “learning.” However, in certain cases traditional techniques that were employed to construct vectors could be quite difficult as they may involve a great deal of experience. Therefore, these traditional techniques could be difficult to utilize and were often limited to sophisticated users that had this knowledge and experience.

### SUMMARY

Feature vector construction techniques are described. In one or more implementations, an input is received at a computing device that describes a graph query that specifies one of a plurality of entities to be used to query a knowledge base graph. A feature vector is constructed, by the computing device, having a number of indicator variables, each of which indicates observance of a sub-graph feature represented by a respective indicator variable in the knowledge base graph.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ feature vector construction techniques.

FIG. 2 is an illustration of a system in an example implementation in which feature vectors are constructed from a document by a vector construction module 106 of FIG. 1, which is shown in greater detail.

FIG. 3 is an illustration of an example of a knowledge base graph for a social network service in which a graph context is illustrated for a user of the social network service.

FIG. 4 is an illustration of an example of a graph query formed by a graph query language for constructing a feature vector by a vector construction module for data describing a social network service.

FIG. 5 depicts another example of a graph query formed using a graph query language for constructing a feature vector by a vector construction module.

FIG. 6 depicts yet another example of a graph query formed using a graph query language for constructing a feature vector by a vector construction module.

FIG. 7 depicts a further example of a graph query formed using a graph query language for constructing a feature vector by a vector construction module.

FIG. 8 is a flow diagram depicting a procedure in an example implementation in which a feature vector is constructed using a graph query that acts as a template for the feature vector.

### DETAILED DESCRIPTION

### Overview

Machine learning algorithms for tasks like categorization, clustering, recommendations, ranking, and so on may operate on entities (e.g., documents, people, tweets, chemical compounds, and so on) represented using feature vectors. However, traditional techniques used to construct feature vectors suitable for use by the machine learning algorithms may involve specialized knowledge and experience.

Feature vector construction techniques are described herein. In one or more implementations, these techniques leverage knowledge about entities and corresponding relationships that is aggregated in the form of knowledge base graphs, e.g., triple-stores. These knowledge base graphs may represent knowledge in terms of a graph whose nodes represent entities and whose edges represent relationships between such entities. Such a representation of the entities may operate as a source for automatically constructing features describing the entities in the knowledge base graph. Further discussion of techniques that may be used to construct these feature vectors may be found in relation to the following sections.

The following discussion starts with a section describing an example environment and system that is operable to employ the feature vector construction techniques described herein. Example implementations are then described, along with an example procedure. It should be readily apparent that the example implementation and procedure are not limited to performance in the example environment and vice versa, as a wide variety of environments, implementations, and procedures are contemplated without departing from the spirit and scope thereof

### Example Environment

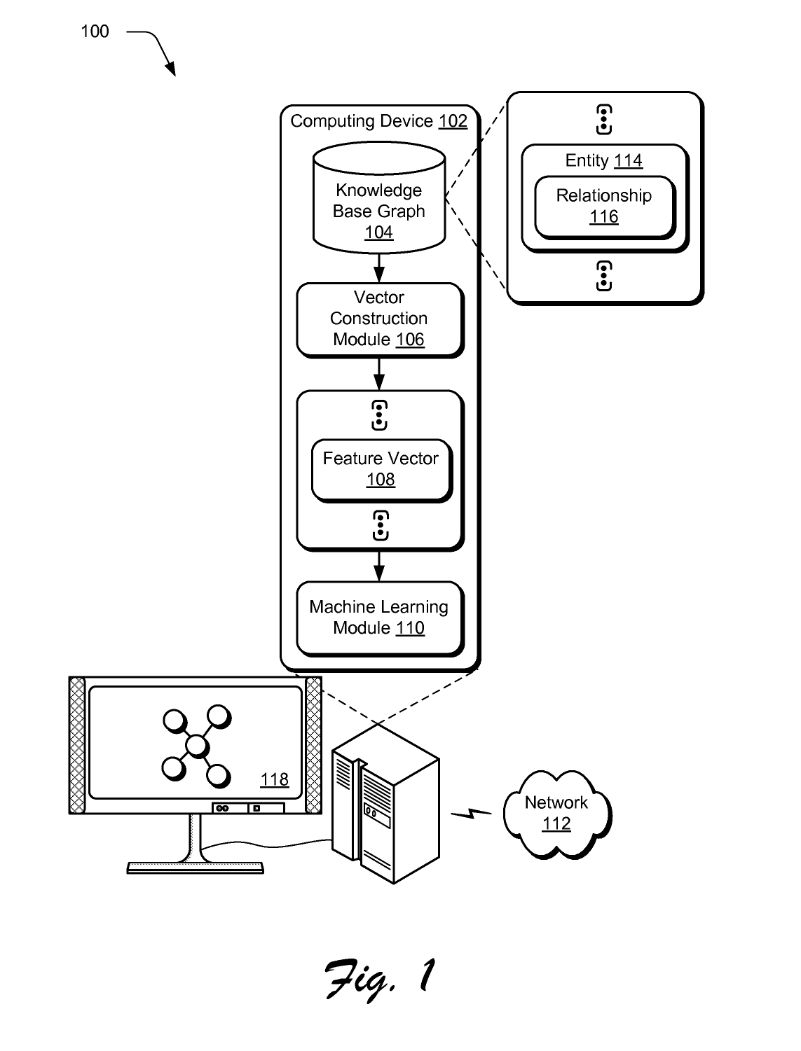

FIG. 1 is an illustration of an environment 100 in an example implementation that is operable to employ techniques described herein. The illustrated environment 100 includes a computing device 102, which may be configured in a variety of ways. For example, the computing device 102 may be configured as a computer that is capable of communicating over a network, such as a desktop computer, a mobile station, an entertainment appliance, a set-top box communicatively coupled to a display device, a wireless phone, a game console, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles). Additionally, although a single computing device 102 is shown, the computing device 102 may be representative of a plurality of different devices, such as multiple servers utilized by a business (e.g., an enterprise, server farm, and so on) to perform operations, a remote control and set-top box combination, an image capture device and a game console configured to capture gestures, and so on.

The computing device 102 may also include entity component (e.g., software) that causes hardware of the computing device 102 to perform operations, e.g., processors, functional blocks, and so on. For example, the computing device 102 may include a computer-readable medium that may be configured to maintain instructions that cause the computing device, and more particularly hardware of the computing device 102 to perform operations. Thus, the instructions function to configure the hardware to perform the operations and in this way result in transformation of the hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via the network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

The computing device 102 is illustrated as including a knowledge base graph 104, a vector construction module 106, one or more feature vectors 108, and a machine learning module 110. Although these components are described as being included in the computing device 102, functionality and data represented by these respective components may be further divided, combined, distributed, e.g., across a network 112, and so on.

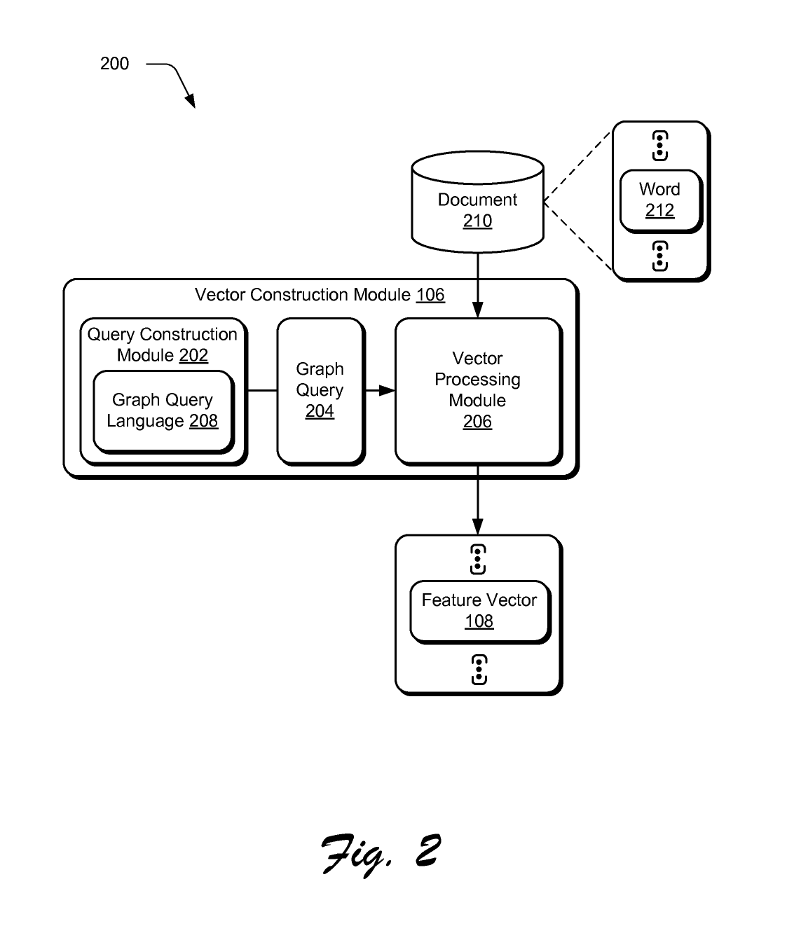

The knowledge base graph 104 in this example represents entities 114 and relationships 116 between the entities 114. For example, the knowledge base graph 104 may be configured to represent pair-wise relationships, such as nodes and edges as further described beginning in relation to FIG. 2.

The vector construction module 106 is representative of functionality of the computing device 102 to construct one or more feature vectors 108 from the knowledge base graph 104. The entities 114 of the knowledge base graph 104, for instance, may have a plurality of different types. For example, an entity “Albert_Einstein” may have a type “physicist” as well as a type “philosopher.” Accordingly, graph queries may be constructed and utilized by the vector construction module 106 that may serve as a basis for constructing the feature vectors 108.

The feature vectors 108 formed by the vector construction module 106 may be utilized for a variety of purposes. For example, a machine learning module 110 may employ machine learning algorithms for tasks like categorization, clustering, recommendations, ranking, and so on using the feature vectors 108. Thus, the feature vector 108 may have a wide variety of different uses, further discussion of which may be found in relation to the following figure.

FIG. 2 is an illustration of a system 200 in an example implementation in which feature vectors are constructed from a document by the vector construction module 106 of FIG. 1, which is shown in greater detail. The vector construction module 106 in this instance is configured as including a query construction module 202 that is configured to construct a graph query 204 for use by a vector processing module 206 to construct one or more feature vectors 108.

The query construction module 202, for instance, is representative of functionality to construct a graph query 204. A user, for instance, may interact with a user interface 118 of the computing device 102 of FIG. 1 to specify the graph query, such as by using one or more graph query languages 208. A variety of different graph query languages 208 may be employed to specify the graph query 204, such as a Simple Protocol and Resource description framework Query Language (SPARQL), NAGA as further described below, and so on.

The graph query 204, may specify an entity “E” of type “T.” The graph query 204 may then be used by the vector processing module 206 to return sub-graphs of a knowledge database graph “KB.” In the illustrated example, the knowledge database graph 118 represents a document 210 having a plurality of words 212 although other knowledge database graphs are also contemplated as previously described.

The sub-graphs returned by the vector processing module 206 contain the entity “E” as specified by the graph query 204. Further, in one or more implementations a number of sub-graphs for entity “E” that are returned is restricted by a number of types to which the entity “E” belongs.

The vector processing module 206 is also configured to construct a set including each possible returned sub-graph for the entity “E” of type “T” as a set of sub-graphs for entity E (the entity of interest). In an implementation, the feature vector 108 constructed from this information by the vector processing module 206 is configured as a feature vector 108 that has length equal to a number of the possible sub-graph features available for entity “E” of type “T.” The feature vector 108 is formed to include indicator variables to describe observance of a feature represented by the respective indicator variables.

In one or more implementations, the feature vector 108 is configured as a binary feature vector having indicator variables that contain a “1” if a corresponding sub-graph feature is present and “0” if a corresponding sub-graph feature is not present. It should be readily apparent that a wide variety of transform functions may be employed by the vector construction module 106 to form the feature vector 108 without departing from the spirit and scope thereof

For example, suppose the knowledge base graph (KB) is configured to represent entities and pair-wise relationships in terms of a graph where the nodes represent the entities and the edges represent the relationships. Feature vector representations may then be formed by the vector construction module 106 for a subset of entities in the knowledge base graph (KB) from its local context in the knowledge base graph. To this end, the graph query language 208 (e.g., NAGA or SPARQL) may be used to form a graph query 204. In one or more implementations, the graph query 204 effectively describes a template for sub-graphs to be returned for the query. Continuing with the previous example, the techniques described herein may take a knowledge base graph 104 “KB,” a graph query 204 “GQ,” an entity type “T,” and an entity “E” of type “T” to return a binary feature vector having a form as follows:

FV(KB, GQ,T,E) for entity E.

As previously described, the feature vector “FV” may be constructed as a vector of indicator variables. Each of the indicator variables may be used to indicate observance of a corresponding feature, such as whether a given sub-graph feature is observed for an entity “E” or not.

Consider now an example of constructing feature vectors for documents 210 based on a “bag-of-words” representation as illustrated in FIG. 2. The following query assumes that “D” is a document and returns each of the words from the document 210 according to the KB:

?W isA Word

D containsWord ?W

In order to construct the feature vector 108, a vocabulary is first determined to find which words the document 210 may contain. The following query returns each of the document/word pairs such that the word is contained in the document.

?D isA Document

?W isA Word

?D containsWord ?W

The feature vector 108 may be constructed in this example as a binary feature vector such that an indicator variable (e.g., an entry) is included for each word in the vocabulary, and the entries take value of “1” if the corresponding word is present and “0” otherwise.

The discussion above is but a simple example of how to construct feature vectors 108 from a knowledge base graph 104. Based on the type system/isA relationship, feature vectors 108 can be constructed which allow a machine learning algorithm to generalize across entities that share a type. Also, by introducing wildcard (e.g., dummy) variables, features may be constructed based on many-to-one lookup tables such as mappings from IP address to geo-location or similar.

Generally, any of the functions described herein can be implemented using software, firmware, hardware (e.g., fixed logic circuitry), manual processing, or a combination of these implementations. The terms “module” and “functionality” as used herein generally represent hardware, software, firmware, or a combination thereof In the case of a software implementation, the module, functionality, or logic represents instructions and hardware that performs operations specified by the hardware, e.g., one or more processors and/or functional blocks.

The instructions can be stored in one or more computer readable media. As described above, one such configuration of a computer-readable medium is signal bearing medium and thus is configured to transmit the instructions (e.g., as a carrier wave) to the hardware of the computing device, such as via the network 104. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data. The features of the techniques described below are platform-independent, meaning that the techniques may be implemented on a variety of commercial computing platforms having a variety of hardware configurations.

### Implementation Examples

As previously described, these techniques may be applied to a variety of different knowledge base graphs 118 that may describe a variety of different data, such as web pages, social network services, Yago, DBPedia, Linked Open Data (LOD), product catalogs of business entities, and so on and use a variety of frameworks for knowledge representation such as RDF, RDFS, OWL, and so forth. Thus, these techniques may be used to navigate through large collections of disparate information, such as the World Wide Web, which bears the potential of being the world's most comprehensive knowledge base. For example, the Web includes a multitude of valuable scientific and cultural content, news and entertainment, community opinions, advertisements. However, this data may also include a variety of other data having limited value, such as spam and junk. Unfortunately, the useful and limited value data may form an amorphous collection of hyperlinked web pages. Accordingly, typically keyword-oriented search engines merely provide best-effort heuristics to find relevant “needles” in this “haystack.”

For example, entities in the knowledge base graph 118 may have a plurality of types. Suppose a query is contemplated to locate physicists who were born in the same year as Albert Einstein. Using traditional search techniques, it is difficult if not impossible to formulate this query in terms of keywords. Additionally, the answer to this question may be distributed across multiple web pages, so that a traditional search engine may not be able to find it. Further, the keywords “Albert Einstein” may stand for different entities, e.g., the physicist Albert Einstein, the Albert Einstein College of Medicine, and so on. Therefore, posing this query to traditional search engines (by using the keywords “physicist born in the same year as Albert Einstein”) may yield pages about Albert Einstein himself, along with pages about the Albert Einstein College of Medicine. This example highlights the limitations found in traditional search engines.

Using the techniques described herein, however, a knowledge base graph 118 may be leveraged with binary predicates, such as Albert Einstein isA physicist or Albert Einstein bornInYear 1879 to overcome the previous limitations. Combined with an appropriate query language and ranking strategies, users may be able to express queries with semantics and retrieve precise information in return.

For example, these techniques maybe employed by a semantic search engine, such as NAGA. The semantic search engine may follow a data model of a graph, in which the nodes represent entities and the edges represent relationships between the entities as previously described. An edge in the graph with its two end-nodes may be referred to as a “fact.” Facts may be extracted from various sources, such as Web-based data sources, social network services, enterprise systems, and so on.

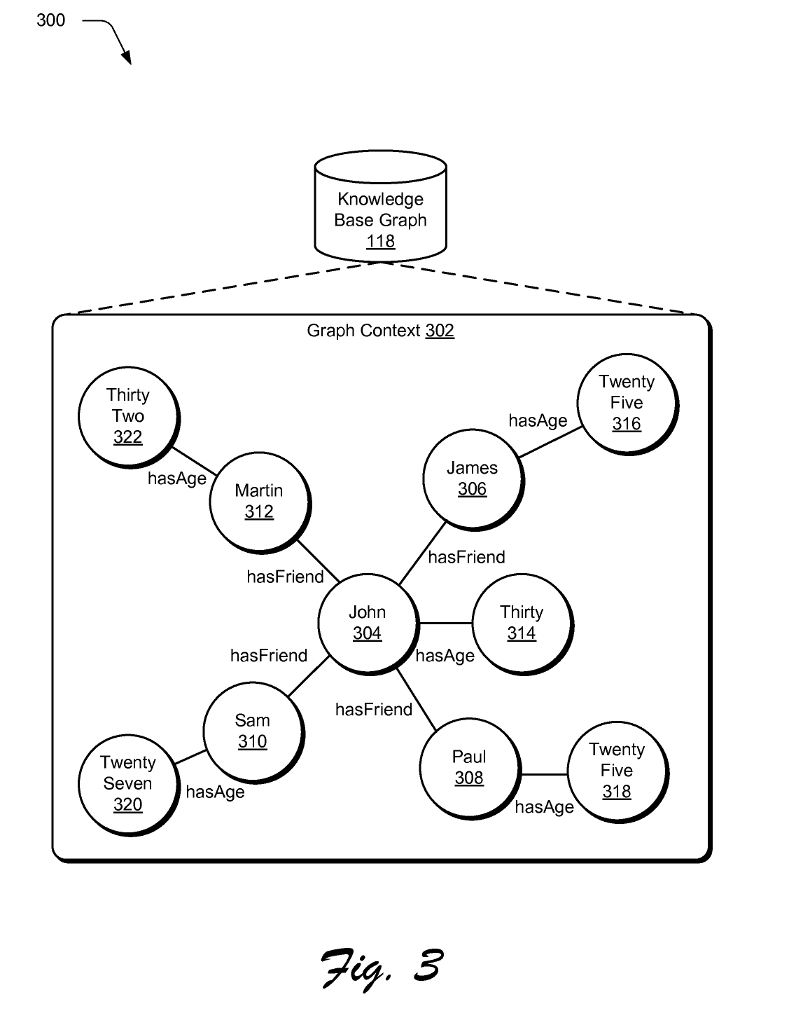

An example of a knowledge base graph 118 is illustrated in an example 300 of FIG. 3 for a social network service in which a graph context 302 is illustrated for an entity John 304, which represents a user of the social network service. Friends of John 304 are illustrated as James 306, Paul 308, Sam 310, and Martin 312. Corresponding ages of these entities are also illustrated, such as thirty 314 for John 304, Twenty Five 316 for James 306, Twenty Five 318 for Paul 308, Twenty Seven 320 for Sam 310, and Thirty Two 322 for Martin 312.

In order to query the knowledge base graph 118, a graph query language 208 may be used as previously described. In implementations, the graph query language 208 allows the formulation of queries with semantic information.

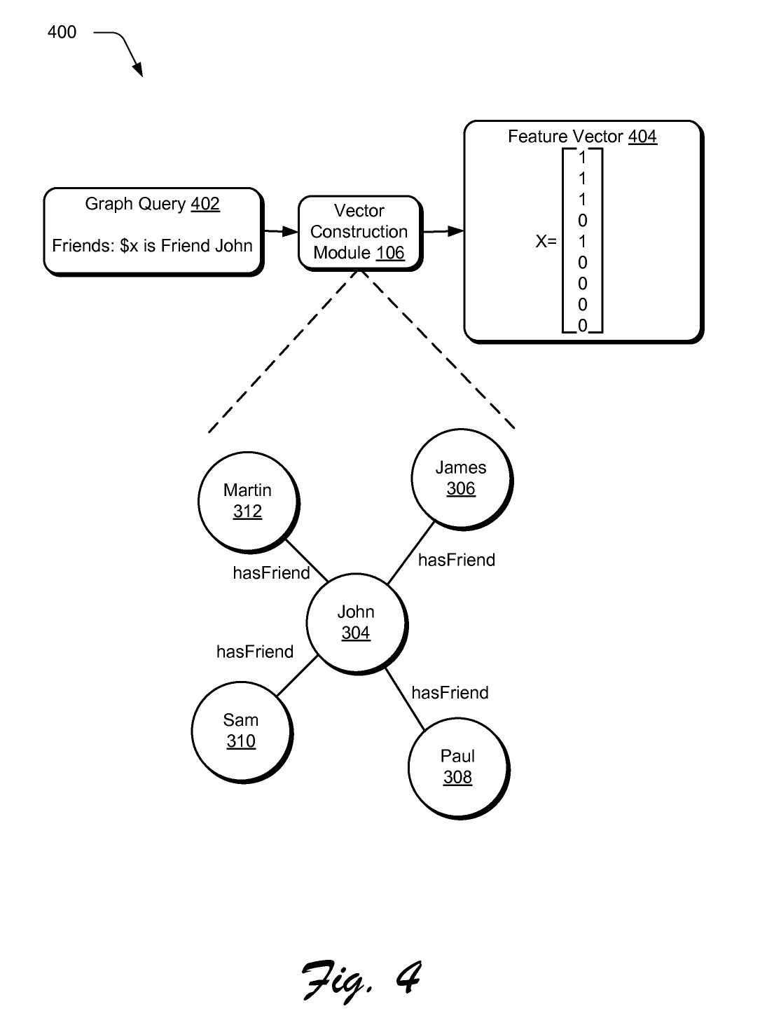

FIG. 4 depicts an example 400 of a graph query formed by a graph query language for constructing a feature vector by a vector construction module 106 for data describing a social network service. In this example, the vector construction module 106 received a graph query 402 having the following form:

Friends: $x is Friend John

The vector construction module 106 may then process the graph context 302 of the knowledge database graph 118 of FIG. 3 to describe the illustrated portion of the graph as a feature vector 404. In this example, the feature vector 404 is a binary feature vector and thus has a number of indicator variables that correspond to a number of features being described having values that describe observance of the feature, e.g., a “1” or a 0” in this example.

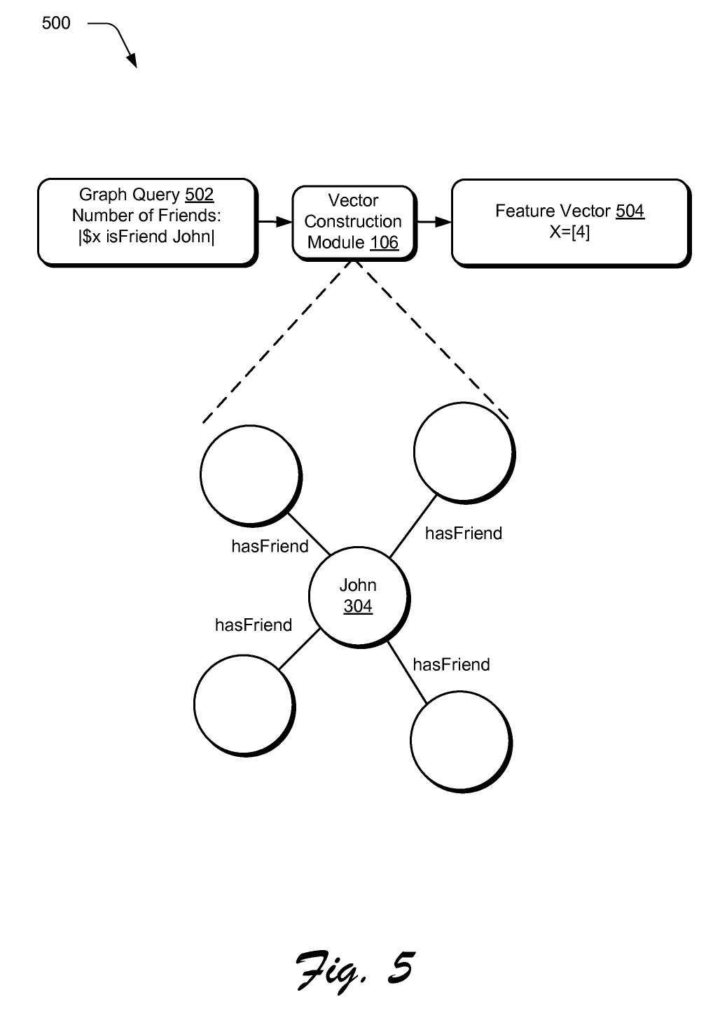

FIG. 5 depicts another example 500 of a graph query formed using a graph query language for constructing a feature vector by a vector construction module 106. In this example, the vector construction module 106 receives a graph query 502 having the following form:

Number of Friends: |$x isFriend John|

Thus, this graph query 502 is configured to determine how many other entities in the knowledge database 118 are indicated as friends of John 304. Accordingly, the vector construction module 106 may process the graph context 302 of the knowledge database graph 118 of FIG. 3 to describe the illustrated portion of the graph as a feature vector 504. In this example, the feature vector 504 has a single indicator variable that describes that John 304 has four friends, and thus represents the portion of the knowledge base graph 118 illustrated below the vector construction module 106.

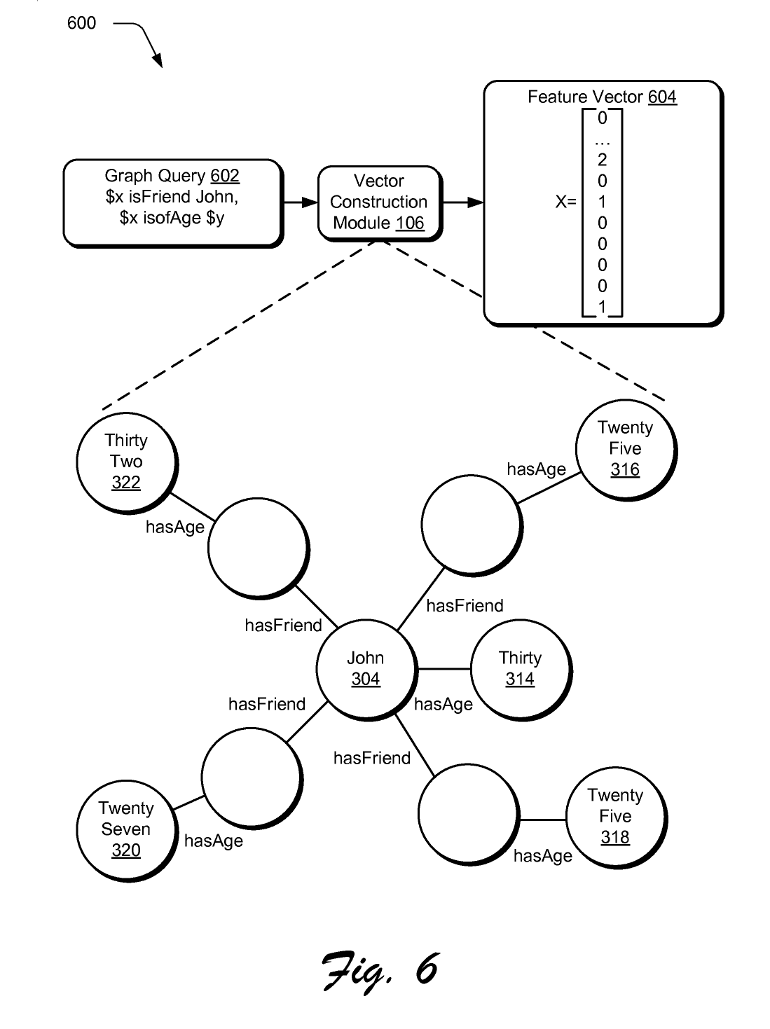

FIG. 6 depicts yet another example 600 of a graph query formed using a graph query language for constructing a feature vector by a vector construction module 106. In this example, the vector construction module 106 receives a graph query 602 having two parts:

$x isFriend John,

$x isofAge $y

Thus, this graph query 502 is configured to determine how many other entities in the knowledge database 118 are indicated as friends of John 304 and that have a particular age. Accordingly, the vector construction module 106 may process the graph context 302 of the knowledge database graph 118 of FIG. 3 to describe the illustrated portion of the graph as a feature vector 604. In this example, the feature vector 604 has a number of indicator variables that correspond to features (e.g., a particular age) that is possible for friends, e.g., starting at “0.” For instance, the feature vector 604 may describe that John 304 has two friends that are twenty five (e.g., twenty five 316, 318), no friends that are twenty six, one friend that is twenty seven (e.g., twenty seven 320), and so on. Again this feature vector 604 may thus represent the portion of the knowledge base graph 118 illustrated below the vector construction module 106. Thus, the feature vector 604 describes observance of particular features (e.g., ages of friends) in the knowledge base graph 118.

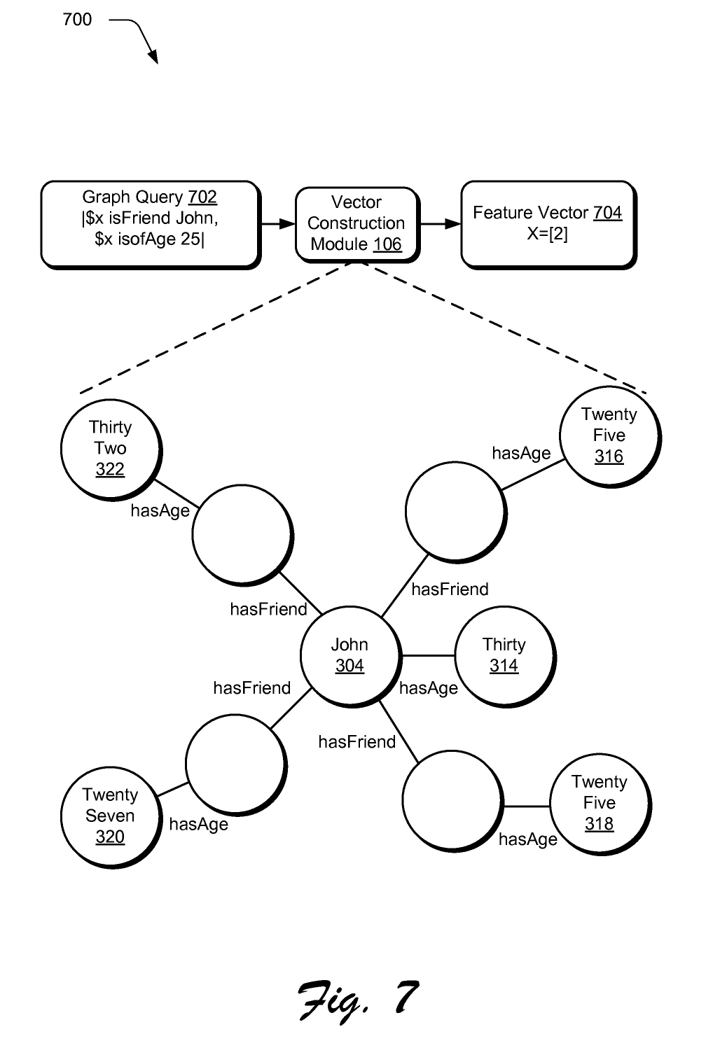

FIG. 7 depicts a further example 700 of a graph query formed using a graph query language for constructing a feature vector by a vector construction module 106. In this example, the vector construction module 106 also receives a graph query 702 having two parts:

$x isFriend John,

$x isofAge 25

Thus, this graph query 702 is configured to determine how many other entities in the knowledge database 118 are indicated as friends of John 304 are twenty five. Accordingly, the vector construction module 106 may process the graph context 302 of the knowledge database graph 118 of FIG. 3 to describe the illustrated portion of the graph as a feature vector 704, which in this case includes a single indicator variable having a value of two.

Thus, as described above the graph query language 208 may be used to support complex graph queries 204 with regular expressions over relationships on edge labels. These techniques may be employed in a variety of ways, such to implement a graph-based knowledge representation model for knowledge extraction from Web-based corpora, data describing enterprise systems, and so on.

### Example Procedure

The following discussion describes feature vector construction techniques that may be implemented utilizing the previously described systems and devices. Aspects of each of the procedures may be implemented in hardware, firmware, or software, or a combination thereof The procedures are shown as a set of blocks that specify operations performed by one or more devices and are not necessarily limited to the orders shown for performing the operations by the respective blocks. In portions of the following discussion, reference will be made to the environment 100 of FIG. 1, the system 200 of FIG. 2, and the examples 300-700 of FIGS. 3-7, respectively.

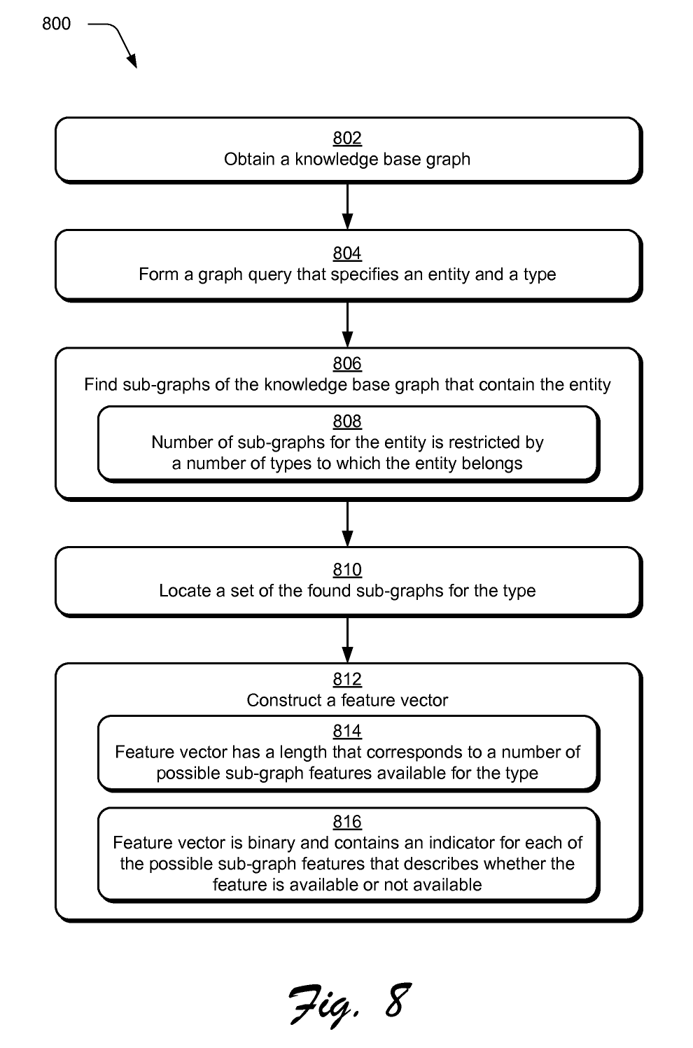

FIG. 8 is a flow diagram depicting a procedure 800 in an example implementation in which a feature vector is constructed using a graph query that acts as a template for the feature vector. A knowledge base graph is obtained (block 802). The knowledge base may be obtained from a variety of sources, such as web services, internet search engines, describe entities in an enterprise, and so forth.

A graph query is formed that specifies an entity and a type (block 804). For example, a graph query language 208 may be employed to form a graph query 204 that may be used as a template for the feature vector 108.

Sub-graphs are found, in the knowledge base graph, which contain the entity (block 806). Further a number of sub-graphs for the entity that are found may be restricted by a number of types to which the entity belongs (block 808). The vector construction module 106, for instance, may process the knowledge database 118 to find entities from the knowledge database graph 118.

A set of the found sub-graphs are located for the type (block 810), e.g., by the vector construction module 106, that include the type specified by the graph query 204.

A feature vector is constructed (block 812). For example, the feature vector may have a length that corresponds to a number of possible sub-graph features available for the type (block 814). The feature vector may also be configured as binary feature vector and contain an indicator for each of the possible sub-graph features that describe whether the feature is available or not available (block 816). Examples of such feature vectors were previously described in relation to FIGS. 2-7. However, it should be readily apparent that a variety of other feature vectors may be formed using a variety of other transform functions without departing from the spirit and scope thereof

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving an input at a computing device that describes a graph query that specifies one of a plurality of entities to be used to query a knowledge base graph that represents the plurality of entities; and
constructing a feature vector, by the computing device, having a number of indicator variables, each of which indicates observance of a sub-graph feature represented by a respective said indicator variable in the knowledge base graph.

2. A method as described in claim 1, wherein the graph query describes a template for the sub-graphs to be returned from the knowledge base graph for the graph query.

3. A method as described in claim 1, further comprising finding one or more sub-graphs in the knowledge base graph that include the entity of the graph query.

4. A method as described in claim 3, wherein a number of the one or more sub-graphs in the knowledge base graph that are found is restricted by a number of entities belonging to a type to which the entity belongs in the knowledge base graph.

5. A method as described in claim 1, wherein the observance describes whether a sub-graph feature represented by the respective said indicator variable is observed or not observed for the entity in the knowledge base graph.

6. A method as described in claim 1, wherein the knowledge base graph includes nodes that represent entities and edges that represent relationships between the entities.

7. A method as described in claim 1, wherein the knowledge base graph represents a plurality of entities through pairwise relationships such that one or more of the entities have a plurality of different types.

8. A method as described in claim 1, wherein the feature vector is a binary feature vector “FV” formed from the graph query “GQ” for the entity “E” in the knowledge base graph “KB” has a form of FV(KB, GQ, T, E).

9. A method as described in claim 1, wherein the graph query is written using a graph query language.

10. A method as described in claim 1, further comprising applying one or more machine learning or information retrieval algorithms to the feature vector.

11. A method as described in claim 10, wherein the one or more machine learning algorithms are configured to perform tasks selected from categorization, clustering, recommendation, or ranking.

12. A method comprising:
receiving an input at a computing device that describes a graph query that specifies an entity and a graph pattern for which matches are to be found in a knowledge base graph;
finding sub-graphs in a knowledge base graph that contain the entity and match the graph pattern; and
constructing a feature vector, by the computing device, having indicator variables that indicate observance of respective features by the sub-graphs in the knowledge base graph.

13. A method as described in claim 12, wherein a number of the sub-graphs found for the entity is restricted by a number of types to which the entity belongs.

14. A method as described in claim 12, wherein the finding is performed to find each possible sub-graph for the entity having the type.

15. A method as described in claim 12, wherein the graph query describes a template for the sub-graphs to be returned from the knowledge base graph for the graph query.

16. A method as described in claim 12, wherein the feature vector is a binary feature vector “FV” formed from the graph query “GQ” for the entity “E” in the knowledge base graph “KB” and has a form of FV(KB, GQ, T, E).

17. A method as described in claim 10, further comprising applying one or more machine learning algorithms to the feature vector to perform a ranking task regarding search results in an Internet search.

18. A method as described in claim 10, further comprising applying one or more machine learning algorithms to the feature vector to perform a recommendation task.

19. A computing device having one or more modules implemented at least partially in hardware to perform operations comprising:
forming a graph query using a graph query language, the graph query referencing an entity having a type;
returning sub-graphs of a knowledge base graph that contain the entity of the graph query, wherein a number of the sub-graphs for the entity is restricted by a number of types of the knowledge database graph to which the entity of the graph query belongs;
building a set of each of the sub-graphs that are possible to be returned for the entity of the type referenced by the graph query as a set of the sub-graphs that are returnable for the type specified by the graph query; and
constructing a binary feature vector that has indicator variables describing whether a corresponding said feature is or is not observed in the knowledge database graph as a result of the building.

20. A computing device as described in claim 19, wherein the binary feature vector “FV” formed from the graph query “GQ” for the entity “E” in the knowledge base graph “KB” has a form of FV(KB, GQ, T, E).
